(19) United States
(12) Patent Application Publication
(10) Pub. No.: US 2022/0000700 A1
(43) Pub. Date: Jan. 6, 2022

(54) ASSIST DEVICE

(71) Applicant: JTEKT CORPORATION, Osaka-shi (JP)

(72) Inventors: Yoshitaka YOSHIMI, Kashiba-shi (JP); Toshiki KUMENO, Kyoto-shi (JP)

(73) Assignee: JTEKT CORPORATION, Osaka-shi (JP)

(21) Appl. No.: 17/305,188

(22) Filed: Jul. 1, 2021

(30) Foreign Application Priority Data
Jul. 6, 2020 (JP) 2020-116199

(51) Int. Cl. A61H 3/00; A61H 1/02

(52) U.S. Cl. CPC A61H 3/00; A61H 1/0244; A61H 2201/5007; A61H 2201/1652; A61H 2201/5069; A61H 2201/5061

(57) ABSTRACT

An assist device includes a first body-worn unit, second body-worn units, an actuator, a sensor, and a controller including a processing unit configured to obtain a command value for assist torque based on a detection result of the sensor and using correspondence information indicating a relation between a forward swing speed of a leg and a torque compensation value including first and second torque compensation values. The processing unit is configured to perform an adjustment process of changing the first torque compensation value based on the forward swing angle of at least one of right and left legs of a user, in a case where the processing unit obtains the command value.

### CROSS-REFERENCE TO RELATED APPLICATION

This application claims priority to Japanese Patent Application No. 2020-116199 filed on Jul. 6, 2020, incorporated herein by reference in its entirety.

### BACKGROUND

### 1. Technical Field

This disclosure relates to an assist device.

### 2. Description of Related Art

Various assist devices that are worn on the bodies of users (persons) to assist the users in tasks have been proposed. When lifting a heavy object, for example, a user of an assist device can perform the task with a smaller force (with less burden). One such assist device is disclosed in Japanese Unexamined Patent Application Publication No. 2019-206045 (JP 2019-206045 A). This device includes a first body-worn unit that is worn on the upper body of a user including his or her hips, second body-worn units that are worn on the right and left legs of the user, an actuator that generates assist torque for assisting the user in moving his or her hips relatively to his or her thighs and vice versa, and a controller that controls the actuator.

### SUMMARY

In the assist device disclosed in JP 2019-206045 A, the actuator includes driving units that are mounted on the first body-worn unit so as to be located on right and left sides of the hips of the user. The actuator further includes arms. Each arm has its leading end mounted on the second body-worn unit and its base end mounted on the driving unit, and swings back and forth around the base end. The swing angle of the arm is detected by a sensor, and the controller obtains an assist torque command value based on the swing angle.

Thus, the assist torque command value is obtained based on the swing angles of the arms, i.e., the angles of the legs (thighs) of the user. The actuator operates at an output based on the command value, to provide the user with an assist force. In this case, for example, when the user in an upright standing posture moves his or her legs a little, for example, when the user changes the positions of his or her right and left legs in a front-back direction to change his or her standing posture and not to perform an action of lifting a load etc., the swing angles of the arms change and the assist torque command value is obtained based on this change. As a result, the assist device generates assist torque and may thereby cause the user to have a feeling of discomfort.

This disclosure provides an assist device that can reduce the likelihood of causing the user to have a feeling of discomfort.

An assist device according to one aspect of the disclosure includes a first body-worn unit that is worn at least on hips of a user; second body-worn units that are worn on thighs of right and left legs of the user; an actuator configured to generate assist torque that assists the user in moving the hips of the user relatively to the thighs of the user, and moving the thighs of the user relatively to the hips of the user; a sensor configured to detect forward swing angles of the right and left legs of the user; and a controller configured to repeatedly perform a process of obtaining a command value for the assist torque to be generated, and perform control to operate the actuator at an output based on the command value. The controller includes a processing unit configured to obtain the command value based on a detection result of the sensor and using correspondence information that indicates a relation between a forward swing speed of a leg of the right and left legs and a torque compensation value including a first torque compensation value and a second torque compensation value, the first torque compensation value being a value of basic torque, the second torque compensation value being a torque value that increases with an increase in the forward swing speed of the leg that is an idling leg. The processing unit is configured to perform an adjustment process of changing the first torque compensation value based on the forward swing angle of at least one of the right and left legs of the user, in a case where the processing unit obtains the command value.

The present inventors developed this disclosure with focus on a difference in the motion of the right and left legs of a user between when the action of the user is a walking action and when the user moves his or her legs a little, for example, when the user changes the positions of his or her right and left legs in a front-back direction to change his or her posture while standing. The assist device having the above configuration obtains the command value for assist torque to be generated using the correspondence information. When obtaining the command value, the processing unit changes the basic torque value (first torque compensation value), which is included in the torque compensation value of the correspondence information, based on the forward swing angle of the leg of the user. Thus, when the user moves his or her legs, for example, to change his or her posture, the first torque compensation value can be reduced, so that generation of large assist torque can be avoided. On the other hand, when the user performs a walking action, the first torque compensation value can be set to a certain value to generate the assist torque required for the walking action. In this way, the assist device can reduce the likelihood of causing the user to have a feeling of discomfort.

When one leg of the right and left legs is present ahead of a posture reference line that passes through an upper body of the user, the forward swing angle of the one leg may be defined as a positive angle, and when one leg of the right and left legs is present behind the posture reference line, the forward swing angle of the one leg may be defined as a negative angle. The processing unit may be configured to, as the adjustment process, select first torque information when the forward swing angle of the idling leg of the user is equal to or smaller than a predetermined angle, select second torque information when the forward swing angle of the idling leg of the user is larger than the predetermined angle, and determine, as the first torque compensation value, a torque compensatory value obtained using selected one of the first torque information and the second torque information. The first torque information may be information that indicates a relation between the forward swing angle of the idling leg of the user and the torque compensatory value. In the first torque information, the torque compensatory value may decrease as the forward swing angle of the idling leg changes from a negative value toward zero. The second torque information may be information that indicates a relation between the torque compensatory value and a value obtained by subtracting the forward swing angle of the idling leg of the user from the forward swing angle of a supporting leg of the user. In the second torque information, the torque compensatory value may remain zero while the obtained value is within a range from a set negative value to a set positive value, and after the obtained value exceeds the set positive value, the torque compensatory value may increase as the obtained value increases.

In this configuration, when the user changes the positions of his or her right and left legs in the front-back direction, for example, to change his or her posture, and the forward swing angle of the idling leg at that time is equal to or smaller than the predetermined angle, the first torque information is selected. According to the first torque information, when the forward swing angle of the idling leg is small, for example, close to zero, the torque compensatory value is relatively small and the first torque compensation value is set to a small value. As a result, the assist torque command value is set to a small value and generation of large assist torque can be avoided.

When the user changes the positions of his or her right and left legs in the front-back direction, for example, to change his or her posture, and the forward swing angle of the idling leg at that time is larger than the predetermined angle, the second torque information is selected. Also in this case, a value obtained by subtracting the forward swing angle of the idling leg from the forward swing angle of the supporting leg is relatively small. Therefore, according to the second torque information, the torque compensatory value is small and the first torque compensation value is set to a small value. As a result, the assist torque command value is set to a small value and generation of large assist torque can be avoided.

The processing unit may be configured to perform the adjustment process when the forward swing speed of the idling leg of the right and left legs is higher than a predetermined value and equal to or higher than a last value of the forward swing speed of the idling leg, and the last value of the forward swing speed of the idling leg is equal to or lower than the predetermined value, in the case where the processing unit obtains the command value. The forward swing speed of the idling leg is higher than the predetermined value and equal to or higher than the last value of the forward swing speed at the current timing of obtaining the assist torque command value, and the forward swing speed of the idling leg was equal to or lower than the predetermined value at the last timing of obtaining the assist torque command value. In this case, it is assumed that the user is highly likely to have just started to move at the current timing of obtaining the assist torque command value, and the adjustment process is performed according to the action of the user.

The processing unit may be configured to perform, instead of the adjustment process, a continuation process of setting a current value of the first torque compensation value to a same value as a last value of the first torque compensation value when the forward swing speed of the idling leg of the right and left legs of the user is higher than a predetermined value and equal to or higher than a last value of the forward swing speed of the idling leg, and the last value of the forward swing speed of the idling leg is higher than the predetermined value, in the case where the processing unit obtains the command value. The forward swing speed of the idling leg was higher than the predetermined value at the last timing of obtaining the assist torque command value, and the forward swing speed of the idling leg is higher than the predetermined value also at the current timing of obtaining the assist torque command value. In this case, it is assumed that the user is highly likely to continue walking at the current timing of obtaining the assist torque command value, and the first torque compensation value is maintained.

The processing unit may be configured to perform, instead of the adjustment process, a reduction process of setting a current value of the first torque compensation value to a value obtained by multiplying a last value of the first torque compensation value by a coefficient smaller than 1 when the forward swing speed of the idling leg of the right and left legs of the user is higher than a predetermined value and lower than a last value of the forward swing speed of the idling leg, in the case where the processing unit obtains the command value. In this case, the forward swing speed of the idling leg is lower at the current timing of obtaining the assist torque command value than at the last timing of obtaining the assist torque command value, and therefore the first torque command value is reduced. As a result, assist torque smaller than the last value of the assist torque can be provided to the user.

The processing unit may be configured to perform, instead of the adjustment process, a zero setting process of setting a current value of the first torque compensation value to zero when the forward swing speed of the idling leg of the right and left legs of the user is equal to or lower than a predetermined value, in the case where the processing unit obtains the command value. In this case, it is assumed that the user is substantially stationary, and generation of assist torque can be avoided.

The assist device having these aspects can reduce the likelihood of causing the user to have a feeling of discomfort.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing the overall configuration of one example of an assist device;

FIG. 2 is an exploded perspective view of the assist device shown in FIG. 1;

FIG. 3 is a side view showing a user wearing the assist device shown in FIG. 1;

FIG. 4 is a side view showing the user wearing the assist device shown in FIG. 1;

FIG. 5 is an exploded view of a right driving unit;

FIG. 6 is a sectional view of the right driving unit;

FIG. 7 is a block diagram showing a control device etc. included in the assist device;

FIG. 8 is a graph illustrating one example of correspondence information;

FIG. 9 is a flowchart showing one example of a process of obtaining an assist torque command value;

FIG. 10 is an illustration of the user wearing the assist device;

FIG. 11 is a flowchart showing a process of selecting a preliminary process;

FIG. 12 is a table listing conditions for selecting preliminary processes;

FIG. 13 is a block diagram showing an adjustment process; and

FIG. 14 is a perspective view showing an assist device in another form.

### DETAILED DESCRIPTION OF EMBODIMENTS

Overall Structure of Assist Device

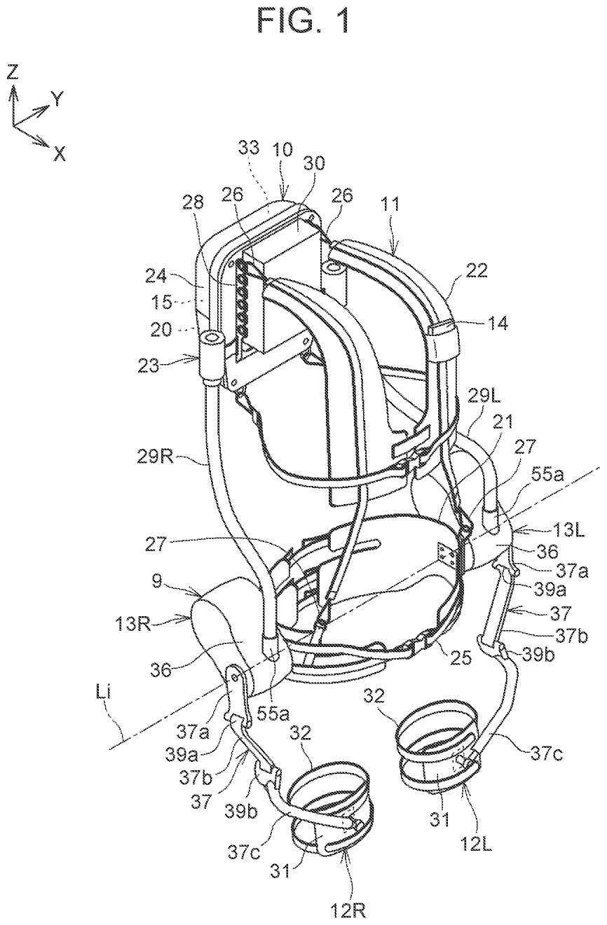

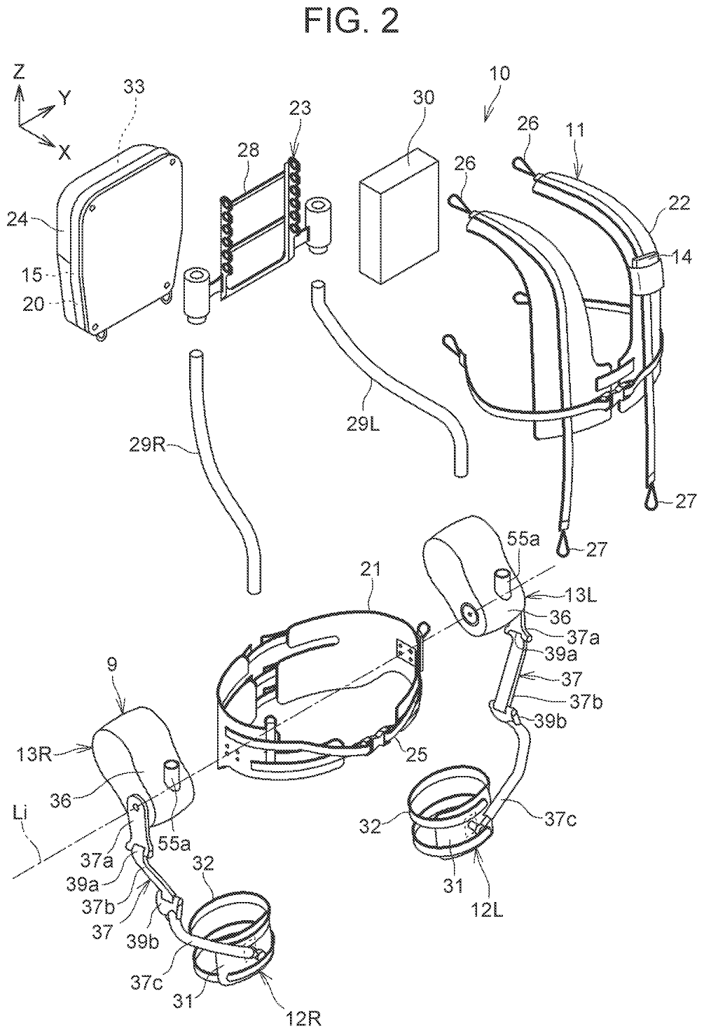

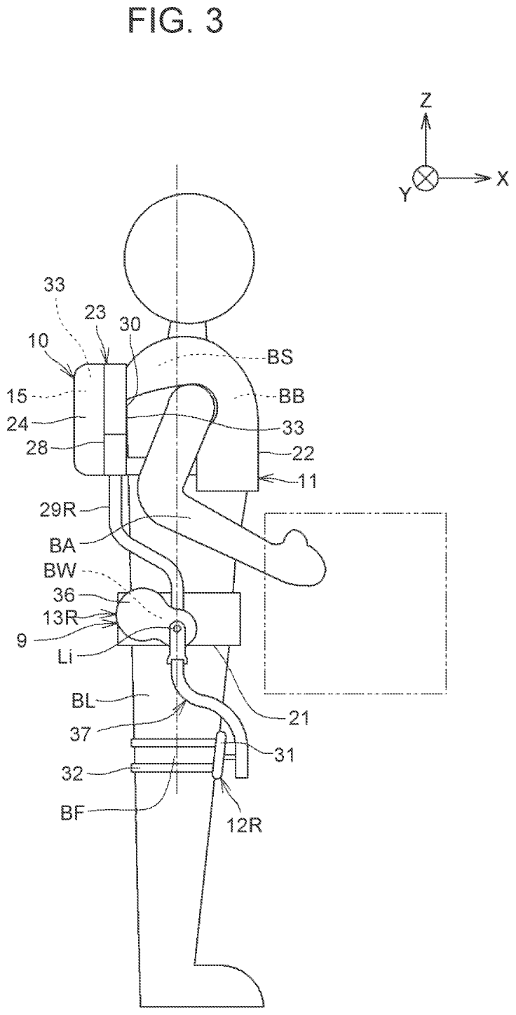

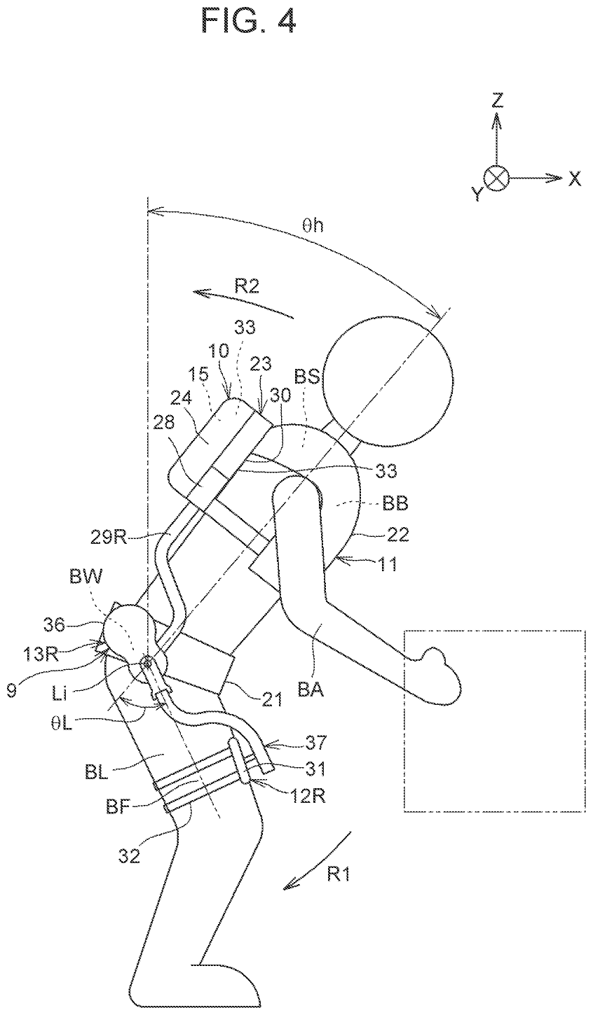

FIG. 1 is a perspective view showing the overall configuration of one example of an assist device. FIG. 2 is an exploded perspective view of the assist device shown in FIG. 1. FIG. 3 and FIG. 4 are side views each showing a user wearing the assist device shown in FIG. 1. In FIG. 3, the user is in an upright standing posture, and in FIG. 4, the user is in a forward leaning posture.

An assist device 10 is a device that assists a user in turning his or her legs BL (thighs BF) relatively to his or her hips BW, for example, when the user lifts a load and lowers a load, and assists the user in turning his or her legs BL (thighs BF) relatively to his or her hips BW when the user walks. Operation of the assist device 10 providing the user with physical assistance will be referred to as “assist operation.”

The X-axis, Y-axis, and Z-axis in the drawings are orthogonal to each other. For the user who is wearing the assist device 10 in an upright standing posture, an X-axis direction, a Y-axis direction, and a Z-axis direction correspond to a frontward direction, a leftward direction, and an upward direction, respectively. With regard to assist operation, assisting the user in turning his or her legs BL (thighs BF) relatively to his or her hips BW as mentioned above is the same as assisting the user in turning his or her hips BW relatively to his or her legs BL (thighs BF). Assist operation is operation of assisting the user by providing the user with torque around an imaginary line Li that passes through the user at a position near his or her hips BW and extends in a right-left direction. This torque will be also referred to as “assist torque.”

The assist device 10 shown in FIG. 1 includes a first body-worn unit 11, right and left second body-worn units 12R, 12L, and an actuator 9 that generates assist torque for assisting the user in moving his or her hips BW relatively to his or her thighs BF and vice versa. “Moving his or her hips BW relatively to his or her thighs BF and vice versa” means moving his or her thighs BF relatively to his or her hips BW and moving his or her hips BW relatively to his or her thighs BF. In the form shown in FIG. 1, the actuator 9 includes right and left driving units 13R, 13L.

The first body-worn unit 11 includes a hip support 21 and a jacket 22 and is worn on the upper body of the user including at least his or her hips BW. The right and left second body-worn units 12R, 12L are worn on the right and left thighs BF of the user. The right and left driving units 13R, 13L are interposed between the first body-worn unit 11 and the second body-worn units 12R, 12L and serve as driving parts that perform driving operation to perform assist operation.

The assist device 10 further includes an operation unit 14 and a control device 15. The operation unit 14 is a so-called controller and is a device into which the user inputs specifications of assist operation etc. The specifications of assist operation include an action mode of assist operation, the intensity of assist operation, and the speed of assist operation. Action modes may include, for example, “lowering action” and “lifting action” and may further include “walking.” In this embodiment, “automatic determination” is provided as an action mode. The intensity of assist operation is set in multiple levels. For example, “level 1 (low),” “level 2 (medium),” and “level 3 (high)” are set. The operation unit 14 is provided with selection buttons by which the user selects the specifications of assist operation. The operation unit 14 is attached to the first body-worn unit 11, for example, to the jacket 22. The operation unit 14 and the control device 15 are connected to each other via wire or wirelessly and can communicate with each other. The control device 15 controls the operation of the driving units 13R, 13L according to the information input into the operation unit 14.

The first body-worn unit 11 includes the hip support 21, the jacket 22, a frame 23, and a backpack 24. The hip support 21 is worn around the hips BW of the user. The hip support 21 includes a belt 25. The belt 25 allows the length of the hip support 21 around the hips BW to be changed and is used to fix the hip support 21 to the hips BW. The hip support 21 includes a hard core made of resin or the like and a leather or fabric member. Cases 36 of the driving units 13R, 13L are mounted on right and left sides of the hip support 21. The hip support 21 and the cases 36 are mounted so as to be able to turn in one direction and the other direction around the imaginary line Li extending in the right-left direction.

The jacket 22 is worn around the shoulders BS and the chest BB of the user. The jacket 22 includes first mounting parts 26 and second mounting parts 27. The jacket 22 is coupled to the frame 23 by the first mounting parts 26. The jacket 22 is coupled to the hip support 21 by the second mounting parts 27. The jacket 22 includes a hard core made of resin or the like and a leather or fabric member.

The frame 23 is formed by a member made of metal, such as aluminum alloy. The frame 23 includes a main frame 28, a left sub-frame 29L, and a right sub-frame 29R. The main frame 28 includes a support member 30 on which the back of the user rests. The right sub-frame 29R and the left sub-frame 29L are columnar members that connect the main frame 28 and parts of the right and left driving units 13R, 13L to each other. An upper end of the left sub-frame 29L is coupled to a part of the main frame 28, and a lower end of the left sub-frame 29L is coupled to the case 36 of the left driving unit 13L. An upper end of the right sub-frame 29R is coupled to another part of the main frame 28, and a lower end of the right sub-frame 29R is coupled to the case 36 of the right driving unit 13R. Thus, the right and left driving units 13R, 13L and the frame 23 of the first body-worn unit 11 are integrated, so that the right and left driving units 13R, 13L and the frame 23 (first body-worn unit 11) cannot shift relatively to each other.

The backpack 24 is mounted at a back part of the main frame 28. The backpack 24 is also called a control box and has a box shape, and inside the backpack 24, the control device 15, a power source (battery) 20, an acceleration sensor 33, and others are provided. The power source 20 supplies required electricity to pieces of equipment including the control device 15 and the right and left driving units 13R, 13L.

The right and left second body-worn units 12R, 12L are worn around the right and left thighs BF of the user. The shape of the second body-worn unit 12L for the left thigh BF and the shape of the second body-worn unit 12R for the right thigh BF are mirror images of each other, but both units have the same configuration. The second body-worn unit 12L (12R) includes a pad-like main part 31 formed by a hard core made of metal, resin, or the like and a belt 32 formed by a leather or fabric member. A part of an arm 37 of the driving unit 13L is coupled to the main part 31. The main part 31 comes into contact with a front surface of the thigh BF. The belt 32 allows the length of the second body-worn unit 12R (12L) around the thigh BF to be changed and is used to fix the main part 31 to the thigh BF.

The left driving unit 13L is provided between the first body-worn unit 11 and the second body-worn unit 12L. The right driving unit 13R is provided between the first body-worn unit 11 and the right second body-worn unit 12R. The right and left driving units 13R, 13L are mounted on the first body-worn unit 11 so as to be located on right and left sides of the hips BW of the user. Specifically, the driving units 13R, 13L are mounted on the right and left sides of the hip support 21. The shape of the left driving unit 13L and the shape of the right driving unit 13R are mirror images of each other, but both units have the same configuration and the same function. The left driving unit 13L and the right driving unit 13R can each operate independently of the other and perform a different operation, as well as can synchronously perform the same operation.

Each of the right and left driving units 13R, 13L has a configuration for performing assist operation of providing the user with an assist force. The assist force is torque around the imaginary line Li, and this torque is “assist torque.” The assist device 10 assists the user in turning his or her thighs BF relatively to his or her hips BW with assist torque output by the right and left driving units 13R, 13L.

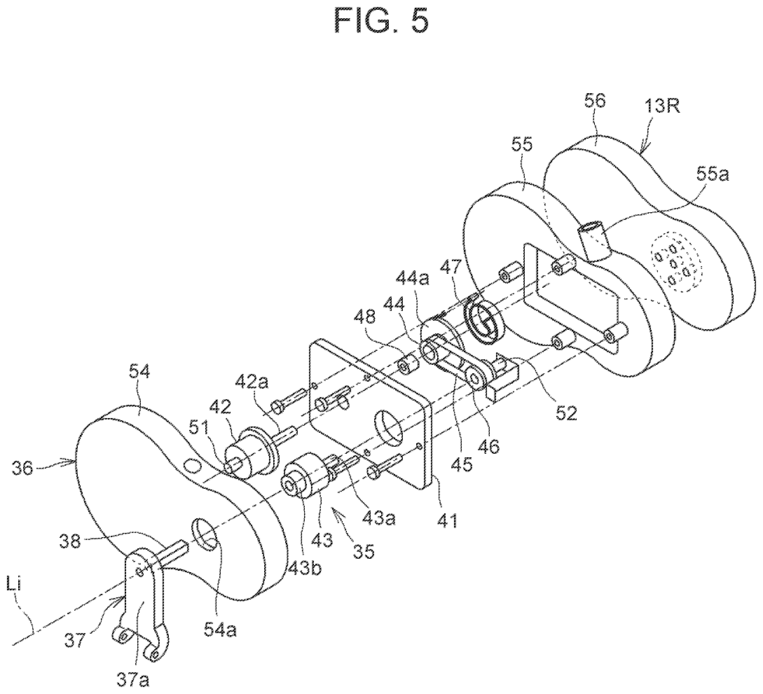

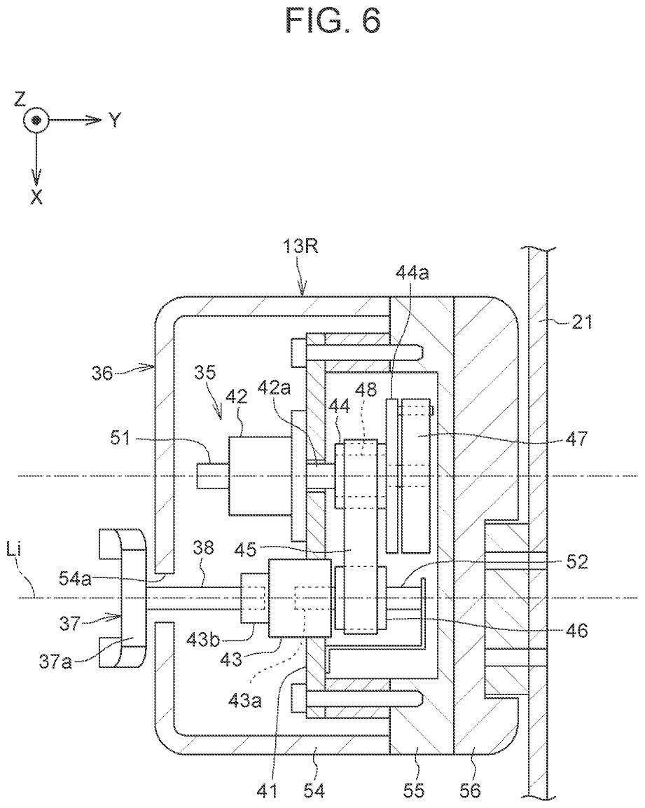

FIG. 5 is an exploded view of the right driving unit 13R. FIG. 6 is a sectional view of the right driving unit 13R. Since the left driving unit 13L and the right driving unit 13R have the same configuration, the configuration of the right driving unit 13R will be described and the description of the left driving unit 13L will be omitted here. The driving unit 13R includes a driving mechanism 35, the case 36 that houses the driving mechanism 35, and the arm 37 to which torque output from the driving mechanism 35 is transmitted. In FIG. 5 and FIG. 6, only a part (first arm part 37a) of the arm 37 is shown.

An assist shaft 38 is fixed at an upper end of the arm 37 (first arm part 37a), and the arm 37 and the assist shaft 38 rotate integrally. The assist shaft 38 is provided in the driving unit 13R so as to be centered on the imaginary line Li. As shown in FIG. 1, a leading end of the arm 37 (third arm part 37c) is coupled to the second body-worn unit 12R.

The driving mechanism 35 is configured as follows. The driving mechanism 35 provides the user with assist torque by swinging (turning) the arm 37 around the imaginary line Li. When the user voluntarily changes his or her posture (see FIG. 3 and FIG. 4), the arm 37 swings (turns) around the imaginary line Li relatively to the case 36.

The specific configuration of the driving mechanism 35 will be described. As shown in FIG. 5 and FIG. 6, the driving mechanism 35 includes a sub-frame 41 that is fixed on the case 36, a motor 42, a speed reducer 43, a first pulley 44 having a flange 44a, a transmission belt 45, a second pulley 46, a spiral spring 47, a bearing 48, a first detector 51, and a second detector 52. The motor 42, the speed reducer 43, and the second detector 52 are mounted on the sub-frame 41. The first pulley 44 is mounted on an output shaft 42a of the motor 42 through the bearing 48, and the first pulley 44 can rotate relatively to the output shaft 42a. An inner peripheral end of the spiral spring 47 is mounted on a leading part of the output shaft 42a. An outer peripheral end of the spiral spring 47 is mounted on the flange 44a of the first pulley 44. The assist shaft 38 is fixed on a speed reducing shaft 43b of the speed reducer 43. The second pulley 46 is mounted on a speed increasing shaft 43a of the speed reducer 43. The transmission belt 45 is wrapped around the first pulley 44 and the second pulley 46. Central axes of the assist shaft 38, the speed reducer 43, and the second pulley 46 coincide with the imaginary line Li.

The case 36 has a split structure. The case 36 includes an outer case 54, a middle case 55, and an inner case 56. The inner case 56 is mounted on the hip support 21 so as to be turnable around the imaginary line Li. The assist shaft 38 is disposed so as to extend through a hole 54a provided in the outer case 54. The middle case 55 includes a mounting part 55a to which the right sub-frame 29R is mounted.

The first detector 51 detects the rotation angle of the output shaft 42a of the motor 42. The second detector 52 directly detects the rotation angle of the second pulley 46. Since the reduction ratio of the speed reducer 43 is constant, the second detector 52 can detect the turning angle of the assist shaft 38. The turning angle of the assist shaft 38 and the swing angle (turning angle) of the arm 37 are the same, and therefore the second detector 52 can detect the swing angle of the arm 37.

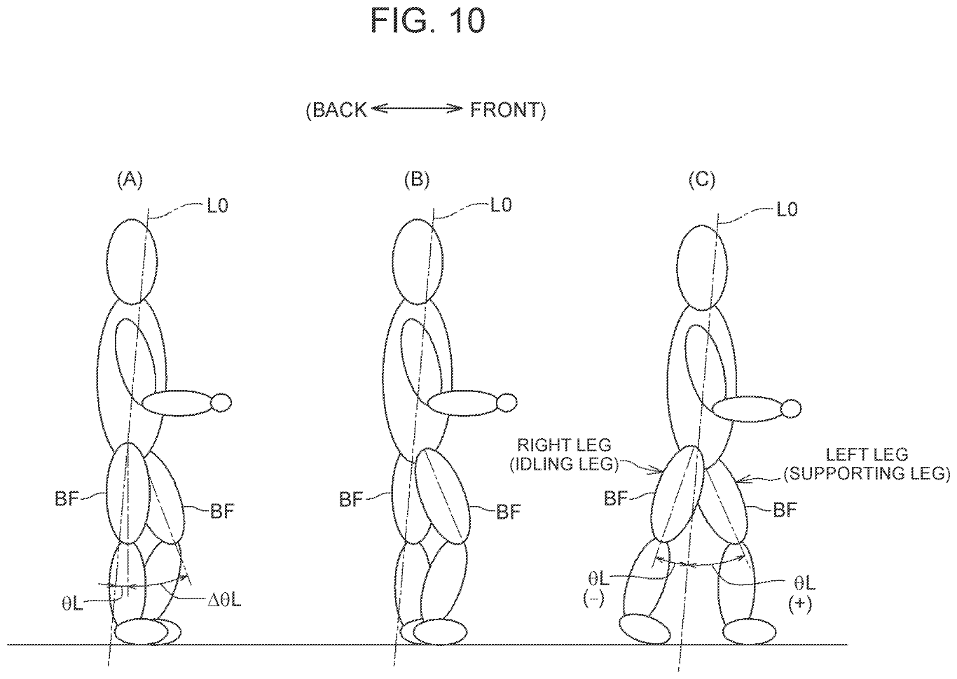

The arm 37 is provided to extend along the thigh BF of the leg of the user. Thus, the swing angle of the arm 37 relative to the first body-worn unit 11 corresponds to the swing angle of the thigh BF of the user relative to his or her upper body. The swing angle of the thigh BF is an angle with respect to a posture reference line L0 (see FIG. 10), and the swing angle of the thigh BF in this case is also referred to as “a forward swing angle of the leg.” As will be described later, the posture reference line L0 is a straight line that passes through the upper body of the user in an up-down direction. The swing angle of the thigh BF, i.e., the forward swing angle of the leg is obtained based on the swing angle of the arm 37.

The swing angle of the arm 37 is obtained by the second detector 52 of the driving unit 13R shown in FIG. 5. The second detector 52 functions as a sensor that detects the swing angle of the arm 37, i.e., the forward swing angle of the leg (thigh BF).

The first detector 51 and the second detector 52 are formed by encoders, angle sensors, or the like. The first detector 51 and the second detector 52 are provided in each of the driving units 13R, 13L and function as detectors for the thigh BF of the right leg and detectors for the thigh BF of the left leg. Detection results of the first detectors 51 and the second detectors 52 are output to the control device 15.

As described above (see FIG. 1), the frame 23 of the first body-worn unit 11 and the right and left driving units 13R, 13L are integrated and cannot shift relatively to each other. When the user changes his or her posture (see FIG. 3 and FIG. 4), the right and left arms 37 turn around the imaginary line Li relatively to the cases 36 of the right and left driving units 13R, 13L. Thus, when the user changes his or her posture, torque is applied to the arms 37. This torque is transmitted from each arm 37 to the second pulley 46 through the assist shaft 38 and the speed reducer 43. The torque transmitted to the second pulley 46 is transmitted to the spiral spring 47 through the transmission belt 45 and the first pulley 44. The torque that is transmitted from the arm 37 through the assist shaft 38 as a result of a change in the posture of the user is accumulated in the spiral spring 47.

When the motor 42 rotates, torque of the motor 42 (motor torque) is accumulated in the spiral spring 47. Thus, in the spiral spring 47, the torque of the motor 42 as well as the user's torque transmitted by an action of the user are accumulated. Combined torque combining the assist torque and the user's torque is accumulated in the spiral spring 47. The combined torque accumulated in the spiral spring 47 is output to the assist shaft 38 through the first pulley 44, the transmission belt 45, the second pulley 46, and the speed reducer 43, and swings the arm 37. Torque that the driving units 13R, 13L output with the use of the torque of the motor 42 is “assist torque” provided by the assist device 10.

The combined torque is obtained based on an amount of change in the angle of the spiral spring 47 from a no-load state and the spring constant of the spiral spring 47. The amount of change in the angle is correlated with the sum of an amount of change in the rotation angle of the output shaft 42a of the motor 42 and an amount of change in the rotation angle of the assist shaft 38. Therefore, the combined torque is obtained based on a detection result of the first detector 51, a detection result of the second detector 52, and the spring constant of the spiral spring 47. Since the detection results of the first detector 51 and the second detector 52 are provided to a processing unit 16 included in the control device 15, the processing unit 16 can obtain the combined torque.

As shown in FIG. 1 and FIG. 2, each arm 37 includes a plurality of arm parts and joints that couple these arm parts together. In this disclosure, each arm 37 includes the first arm part 37a, a second arm part 37b, the third arm part 37c, a first joint 39a, and a second joint 39b. The first joint 39a couples the first arm part 37a and the second arm part 37b on both sides of the first joint 39a together so as to allow them to bend around a central axis that is skew to the imaginary line Li and so as not to allow them to bend around a central axis parallel to the imaginary line Li. The second joint 39b couples the second arm part 37b and the third arm part 37c on both sides of the second joint 39b together so as to allow them to bend around a central axis that is skew to the imaginary line Li and so as not to allow them to bend around a central axis parallel to the imaginary line Li. A lower end of the third arm part 37c is mounted on the main part 31 of the second body-worn unit 12R (12L) so as to be able to bob. This configuration allows the second body-worn unit 12R (12L) to be securely mounted on the thigh BF of the user according to his or her body size, and also facilitates a walking action etc.

The arm 37 includes the joints 39a, 39b but can transmit torque around the imaginary line Li to the second body-worn unit 12R (12L). When the user changes his or her posture (see FIG. 3 and FIG. 4), the second body-worn unit 12R (12L) is pressed by the thigh BF and the arm 37 swings around the imaginary line Li. Thus, the arm 37 can transmit a force that an action (a change in the posture) of the user exerts on the second body-worn unit 12R (12L) to the assist shaft 38 as torque around the imaginary line Li. The arm 37 may have a form different from that shown in the drawings.

As has been described above, the actuator 9 includes the right and left arms 37 and the second detectors 52 that detect the swing angles of the arms 37. Each arm 37 has its leading end mounted on the second body-worn unit 12 and its base end mounted on the assist shaft 38 of the driving unit 13L (13R), and swings back and forth around the base end. In the following description, the second detector 52 will be referred to as a “swing angle sensor 52.”

The assist device 10 further includes a tilt angle detection part that obtains a tilt angle θh (see FIG. 4) of the upper body of the user that is an upper part of the user's body including his or her hips BW. The tilt angle detection part in this embodiment is a triaxial acceleration sensor (tilt angle sensor) 33. The acceleration sensor 33 is provided, for example, in the backpack 24. The tilt angle detection part may have another form as long as it is configured to, like the triaxial acceleration sensor 33, output a signal corresponding to the posture (tilt angle) of the upper body of the user.

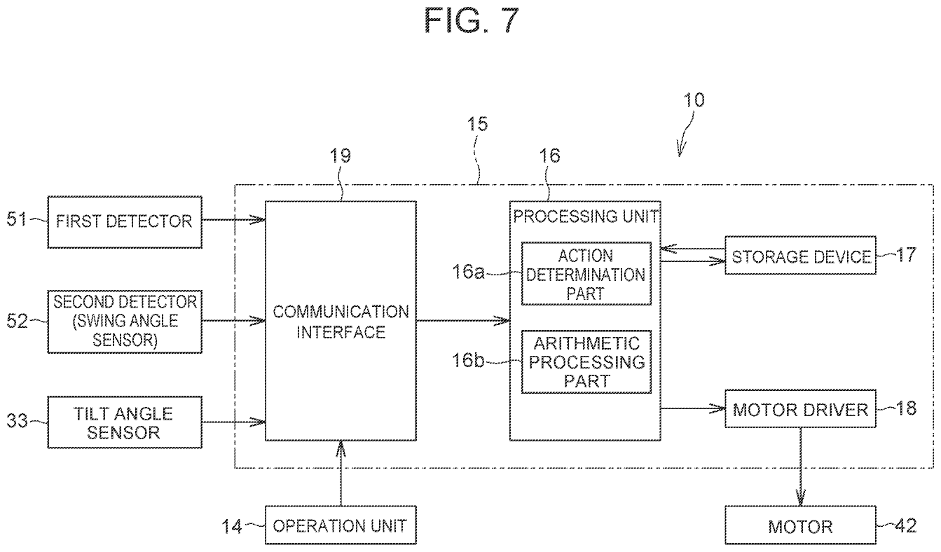

FIG. 7 is a block diagram showing the control device 15 etc. included in the assist device 10. The control device 15 obtains an assist torque command value as an assist parameter for determining assist torque to be generated, and performs control to operate the actuator 9 at an output based on the command value.

To obtain the assist torque command value and control the actuator 9, the control device 15 includes the processing unit (processing device) 16 including a central processing unit (CPU), a storage device 17 formed by a non-volatile memory or the like that stores information, such as various programs and databases, a motor driver 18, and a communication interface 19.

The processing unit 16 can have various functions by executing computer programs stored in the storage device 17. The processing unit 16 functions to obtain an assist torque command value and to give commands for executing assist operation with the use of the driving units 13R, 13L. Specifically, as functional parts that operate in accordance with computer programs stored in the storage device 17, the processing unit 16 includes an action determination part 16a that determines the action of the user and an arithmetic processing part 16b that performs a process of obtaining an assist torque command value. Specific processes performed by these functional parts will be described later.

The function of giving commands for executing assist operation with the use of the driving units 13R, 13L will be described. For example, when a selection button of the operation unit 14 (see FIG. 7) is selected by the user, the processing unit 16 performs assist operation in accordance with a program for the action corresponding to that selection button. The processing unit 16 functions to perform assist operation for a “lowering action,” a “lifting action,” etc. in accordance with programs stored in the storage device 17. The processing unit 16 functions to, when detecting “walking” as the action mode, perform assist operation for “walking” in accordance with a program stored in the storage device 17. As the programs, a walking program, a lifting program, and a lowering program are stored in the storage device 17. For example, when a button in the operation unit 14 corresponding to a “lifting action” is selected by the user's operation, the processing unit 16 performs assist operation for a lifting action in accordance with the lifting program.

The action determination part 16a of the processing unit 16 determines the action of the user based on a detection result of one or both of the triaxial acceleration sensor 33 and the swing angle sensors 52, and according to the determination result, one of the walking program, the lifting program, and the lowering program is selected and performed. As the process of determining the action of the user, a commonly known process can be adopted; for example, the determination process disclosed in Japanese Unexamined Patent Application Publication No. 2018-199206 (JP 2018-199206 A) is adopted. In the operation unit 14, “automatic determination” is provided as a selection button for the action mode, and when this automatic determination is selected, the action determination part 16a functions.

In the case where the assist device 10 provides assistance for “walking,” a “lifting action,” or a “lowering action,” the arithmetic processing part 16b of the processing unit 16 obtains a command value for the required assist torque, and generates a command signal that causes the driving units 13R, 13L to output assist torque corresponding to that command value. This command signal is provided to the motor driver 18.

The motor driver 18 is configured to include an electronic circuit, for example, and outputs a driving current for driving the motor 42 based on the command signal from the arithmetic processing part 16b. The motor driver 18 activates the driving units 13R, 13L based on the command signal. The motor driver 18 functions as an activation control part that activates the driving units 13R, 13L based on the signal (command signal) corresponding to the assist torque command value. Signals from each of the operation unit 14, the first detectors 51, the second detectors (swing angle sensors 52), and the acceleration sensor 33 are input into the communication interface 19, which then provides these signals to the processing unit 16. Information input into the operation unit 14, such as the specifications of assist operation, is input into the processing unit 16 through the communication interface 19, and the processing unit 16 performs processes using the input information.

Overview of Assist Operation

As described above, the assist device 10 performs assist operation by operating the right and left driving units 13R, 13L. Assist operation is operation of providing assist torque around the imaginary line Li passing through the user at a position near his or her hips BW and extending in the right-left direction, to the user through the first body-worn unit 11 and the second body-worn units 12R, 12L.

Examples of actions of the user include an upright standing action (also called a “lifting action”) in which the user changes the posture of his or her upper body from a forward leaning posture to an upright standing posture to lift a load; a forward leaning action (also called a “lowering action”) in which the user changes the posture of his or her upper body from an upright standing posture to a forward leaning posture to lower a load; and an action in which the user walks.

Regardless of whether the user performs a lifting action or a lowering action, assist torque generated by the assist device 10 is torque in a direction of changing the posture of the user from a forward leaning posture to an upright standing posture. That is, the direction in which the right and left driving units 13R, 13L try to turn (swing) the arms 37 around the imaginary line Li (see FIG. 4) is the direction of arrow R1, and the direction in which the right and left driving units 13R, 13L try to turn the first body-worn unit 11 (frame 23) around the imaginary line Li is the direction of arrow R2. For example, when the user performs a lifting action, the pad-like main parts 31 of the right and left second body-worn units 12R, 12L push the right and left thighs BF backward by assist torque in the direction of arrow R1. The frame 23 of the first body-worn unit 11 pulls the upper body of the user toward the back side (backward) by assist torque in the direction of arrow R2.

When the assist device 10 performs assist operation for walking on the user, this assist operation is operation of assisting the user in turning his or her thighs BF relatively to his or her hips BW, and the right and left driving units 13R, 13L alternately perform the operation to assist turning. Thus, the right and left driving units 13R, 13L alternately swing the right and left arms 37 at predetermined assist torque.

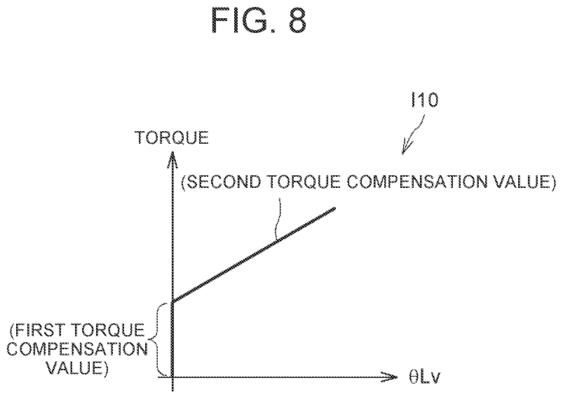

The command value for the assist torque that is output by the driving units 13R, 13L for the assist device 10 configured as described above to perform assist operation is determined by the arithmetic processing part 16b. The assist torque that the driving units 13R, 13L provide to the user is based on the output torque of the motor 42. To increase the assist torque provided to the user, the output torque of the motor 42 should be increased, and to reduce the assist torque provided to the user, the output torque of the motor 42 should be reduced. As will be described with examples later (see FIG. 8), the assist torque command value is obtained based on detection results of the swing angle sensors 52 and using correspondence information I10 that indicates a relation between a torque compensation value and a forward swing speed τLv of the leg of the user. In the following, a process of obtaining the assist torque command value will be described.

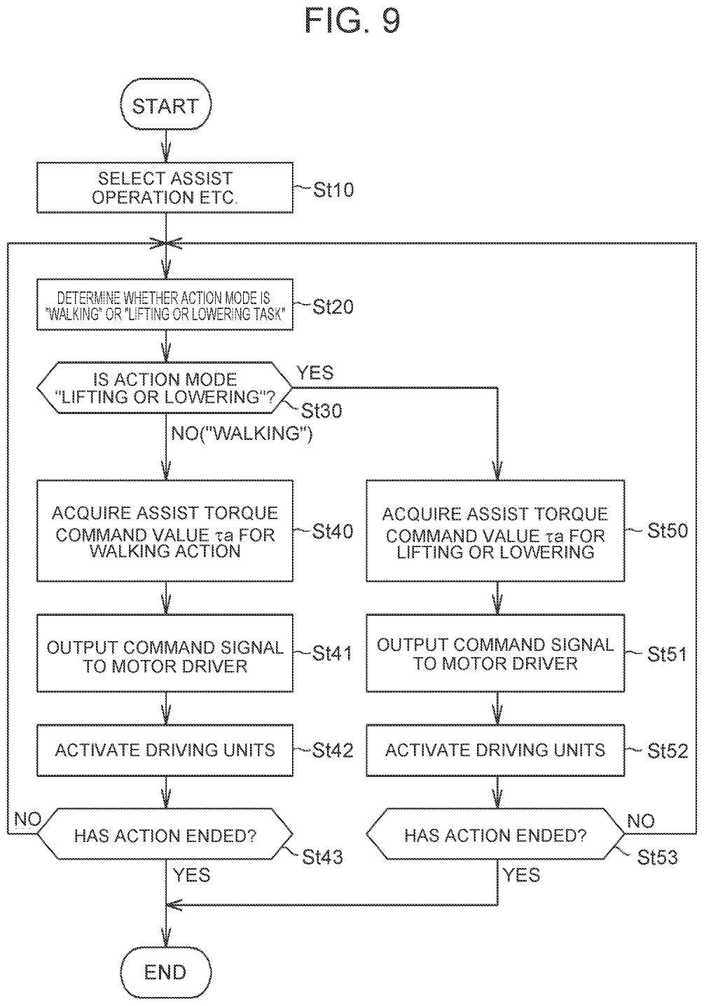

FIG. 9 is a flowchart showing one example of the process of obtaining the assist torque command value. As shown in step St10 of FIG. 9, when “lifting action” is selected in the operation unit 14, the control device 15 starts a process of executing assist operation for lifting. When the control device 15 (processing unit 16) determines that the action mode is a “walking action,” it starts a process of executing assist operation for a walking action (steps St20 and St30 of FIG. 9). Determination of a walking action is made based on a detection result of each of the triaxial acceleration sensor 33 and the swing angle sensors 52 or detection results of the swing angle sensors 52. Alternatively, when action automatic determination is selected in the operation unit 14, the action determination part 16a determines the action of the user based on a detection result of each of the triaxial acceleration sensor 33 and the swing angle sensors 52 or detection results of the swing angle sensors 52 (step St20 of FIG. 9). According to the determination result, the control device 15 starts a process of executing assist operation for the action. That is, the control device 15 selects and performs one of the walking program, the lifting program, and the lowering program.

In the case of the assist operation for lifting or lowering (“Yes” in step St30 of FIG. 9), the arithmetic processing part 16b obtains a command value τa for assist torque for lifting or lowering (step St50 of FIG. 9). When the command value τa is obtained, as described above, a command signal for causing the driving units 13R, 13L to output assist torque corresponding to the command value τa is given to the motor driver 18 (step St51). The motor driver 18 activates the driving units 13R, 13L based on the command signal (step St52). Thus, assist torque for lifting or lowering is provided to the user. The cycle shown in FIG. 9, i.e., the sequence of processes shown in FIG. 9 is repeatedly performed in a predetermined cycle (e.g., the sequence of processes is performed every 0.001 seconds) until the lifting or lowering action is completed.

In the case of the assist operation for walking (“No” in step St30 of FIG. 9), the arithmetic processing part 16b obtains a command value τa for assist torque for a walking action (step St40 of FIG. 9). When the command value τa is obtained, as described above, a command signal for causing the driving units 13R, 13L to output assist torque corresponding to the command value τa is given to the motor driver 18 (step St41). The motor driver 18 activates the driving units 13R, 13L based on the command signal (step St42). Thus, assist torque for a walking action is provided to the user. The cycle shown in FIG. 9, i.e., the sequence of processes shown in FIG. 9 is repeatedly performed on a predetermined cycle (e.g., once every 0.001 seconds) until the walking action ends.

The completion of the lifting or lowering action and the end of the walking action (steps St43 and St53) can be determined, for example, based on a detection result of each of the triaxial acceleration sensor 33 and the swing angle sensors 52 or detection results of the swing angle sensors 52. The process for the right driving unit 13R and the process for the left driving unit 13L are the same and concurrently performed.

Process of Obtaining Assist Torque Command Value τa.

Described below is a process in which the processing unit 16 (arithmetic processing part 16b) obtains the command value τa in the case where “walking” is selected as the action mode or the case where automatic determination is performed by the action determination part 16a and the action mode is determined to be “walking.” FIG. 10 is an illustration of the user wearing the assist device 10. (A) and (B) of FIG. 10 show how the user in an upright standing posture moves his or her legs a little so as to change the positions of his or her right and left legs in the front-back direction to change his or her standing posture. (C) of FIG. 10 shows how the user walks.

First, the definitions of terms will be described. “Supporting leg” is the leg of the user that mainly bears his or her body weight. It is the leg that is overtaken by the other leg (idling leg) in a walking action. “Idling leg” is the leg of the user that does not bear his or her body weight. It is the leg that overtakes the other leg (supporting leg) in a walking action. “Posture reference line L0” is a straight line that passes through the upper body of the user in the up-down direction.

The posture reference line L0 (see FIG. 10) is an imaginary line, and may be a line that extends along the upper body and varies according to the forward leaning posture, or may be a line that is fixed regardless of the posture of the upper body of the user. In the case of a fixed line, the up-down direction includes not only an up-down direction along a vertical line but also a direction inclined at an angle smaller than 30 degrees relatively to the vertical line. In this embodiment, the posture reference line L0 is a fixed line and a straight line inclined at an angle of five degrees toward the front side of the upper body of the user relatively to the vertical line. The posture reference line L0 can be defined, for example, as a straight line that is inclined at an angle equal to or larger than zero degrees and equal to or smaller than 10 degrees toward the front side of the upper body of the user relatively to the vertical line.

“Forward swing angle” is an angle that is formed by the posture reference line L0 and a straight line extending in a longitudinal direction of the thigh BF of the leg, and that is positive when the straight line is located ahead of the posture reference line L0 and negative when the straight line is located behind the posture reference line L0. “Forward swing speed” is a rate of change in the forward swing angle, and is obtained from a change over time in the forward swing angle.

In (C) of FIG. 10 that shows walking, the right leg is the idling leg and the left leg is the supporting leg, and the forward swing angle θL of the idling leg is negative and the forward swing angle θL of the supporting leg is positive. The forward swing angle can also be referred to as a rotational angular speed of the hip joint. The forward swing speed is positive in a direction in which the leg is swung forward.

The forward swing angle is obtained based on the swing angle θL of the arm 37 detected by the swing angle sensor 52. The swing angle sensor 52 detects the forward swing angle (the swing angle of the arm 37) on a moment-to-moment basis, and a process of obtaining the command value τa for assist torque to be generated is repeatedly performed using the detected forward swing angle. The forward swing angle that is acquired at the current timing of obtaining the command value τa is represented by “τL(t),” and the forward swing angle that was acquired at a timing directly preceding that timing is represented by “τL(t−1).” The forward swing angle is detected in the predetermined cycle (every 0.001 seconds). Therefore, the forward swing speed τLv(t) at the current timing is obtained by “(τL(t)−τL(t−1))/predetermined cycle.” The forward swing speed at the last timing is represented by“τLv(t−1).” Based on a change in the forward swing angle θL, the processing unit 16 can determine whether the forward swing angle θL is a value of the idling leg or a value of the supporting leg.

“Correspondence information I10” is information that indicates a relation between the torque compensation value including a first torque compensation value and a second torque compensation value, to be defined below, and the forward swing speed τLv of the leg (thigh BF). FIG. 8 is a graph illustrating one example of the correspondence information I10. The ordinate and the abscissa in FIG. 8 show the torque compensation value and the forward swing speed τLv of the leg (thigh BF), respectively.

“First torque compensation value” is a value of basic torque that is part of assist torque to be generated. The first torque compensation value is also referred to as an accelerating torque compensation value. The first torque compensation value includes a value of torque that is generated, for example, to offset frictional resistance of the speed reducer 43 of the actuator 9. “Second torque compensation value” is a value of torque that is part of assist torque to be generated and that is added to the first torque compensation value. A minimum value of the second torque compensation value is equal to the first torque compensation value. The second torque compensation value is a value of torque that is added to the first torque compensation value, and that is set to increase with an increase in the forward swing speed τLv of the leg that is the idling leg. The second torque compensation value is also referred to as a viscous torque compensation value. The second torque compensation value includes a value of torque that is required according to the motion of the leg that is the idling leg.

In this embodiment (see FIG. 8), the second torque compensation value is set to a larger value as the forward swing speed τLv of the leg that is the idling leg becomes higher (i.e., the second torque compensation value is set to increase with an increase in the forward swing speed τLv of the leg that is the idling leg). The inclination (the rate of change) of the second torque compensation value is a fixed value that is obtained by computation.

Process of Obtaining Command Value τa.

An example of the process in which the arithmetic processing part 16b of the control device 15 obtains the assist torque command value τa will be described. The arithmetic processing part 16b obtains the command value τa based on detection results of the swing angle sensors 52, i.e., the forward swing angles τL of the legs of the user. The forward swing angles τL of the right and left legs are obtained in a predetermined cycle and at the same timing. When the forward swing angles τL of the right and left legs are obtained, the forward swing speeds τLv of the right and left legs at that timing are obtained using these forward swing angles τL. The obtained forward swing angles τL and the forward swing speeds τLv are stored in the storage device 17. As described above, the forward swing angles τL are detected in the predetermined cycle, and when the forward swing angles τL are detected, the process of obtaining the command value τa is repeatedly performed until the action of lifting, lowering, or walking ends (see FIG. 9).

The arithmetic processing part 16b obtains the command value τa based on detection results of the swing angle sensors 52 and using the correspondence information I10 shown in FIG. 8. More specifically, the arithmetic processing part 16b obtains the command value τa using the correspondence information I10 and based on the forward swing speed τLv that is calculated from the forward swing angles τL that are detection results of the swing angle sensors 52. When obtaining the command value τa, the arithmetic processing part 16b can perform an adjustment process of changing the first torque compensation value included in the correspondence information I10 based on the forward swing angle θL of the thigh BF of the user. The forward swing angle θL of the thigh BF used in the adjustment process is one or both of the forward swing angles τL of the right and left legs of the user. Specific examples of the adjustment process will be described later.

The adjustment process is one of preliminary processes for determining the first torque compensation value and performed when a predetermined condition is met. In this embodiment, one of the adjustment process and other processes, namely, a continuation process, a reduction process, and a zero setting process, is performed as the preliminary process for determining the first torque compensation value. The assist torque command value τa is obtained based on the torque compensation value (the correspondence information I10 of FIG. 8) including the first torque compensation value determined by the preliminary process and the second torque compensation value.

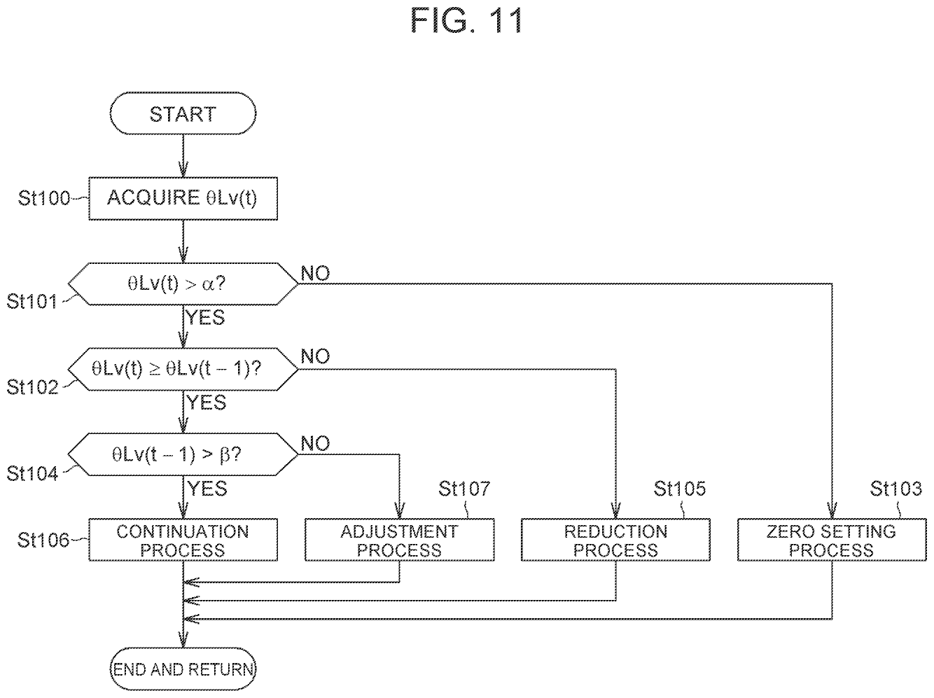

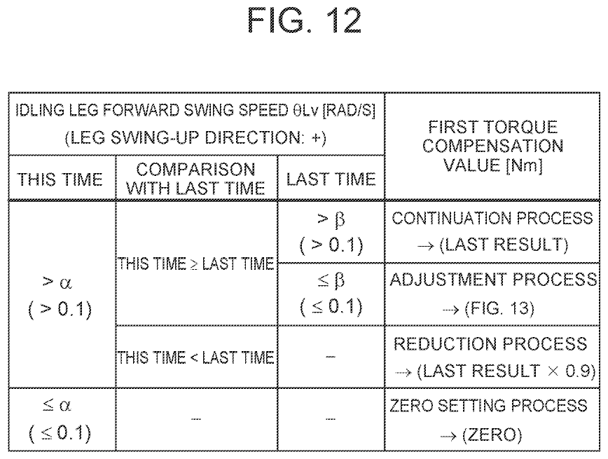

In the following, a specific example will be described using FIG. 11 and FIG. 12 relating to conditions for selecting one of the adjustment process, the continuation process, the reduction process, and the zero setting process, and relating to the first torque compensation value determined by the selected process. FIG. 11 is a flowchart showing a process of selecting a preliminary process. FIG. 12 is a table listing the conditions for selecting the preliminary processes and corresponds to FIG. 11.

In FIG. 11, when the forward swing speed τLv(t) of the idling leg is obtained at the time of obtaining the command value τa (step St100), the forward swing speed τLv and a first predetermined value α (e.g., 0.1 [rad/s]) stored in the storage device 17 are compared (step St101). When τLv(t) is higher than α, the arithmetic processing part 16b moves to step St102.

When the arithmetic processing part 16b moves to step St102, the current forward swing speed τLv(t) and the last forward swing speed τLv(t−1) are compared. When the current forward swing speed τLv(t) is equal to or higher than the last forward swing speed τLv(t−1), the arithmetic processing part 16b moves to step St104.

When the arithmetic processing part 16b moves to step St104, the last forward swing speed τLv(t−1) is compared with a second predetermined value β. The second predetermined value β may be different from the first predetermined value α, but these values are equal (e.g., 0.1 [rad/s]) in this embodiment. When τLv(t−1) is higher than β, the arithmetic processing part 16b moves to step St106. When τLv(t−1) is equal to or lower than β, the arithmetic processing part 16b moves to step St107. When the arithmetic processing part 16b moves to step St106, the continuation process is performed, and when the arithmetic processing part 16b moves to step St107, the adjustment process is performed. The continuation process and the adjustment process will be described later.

When τLv(t) is equal to or lower than α (“No”) in step St101, the arithmetic processing part 16b moves to step St103. When the arithmetic processing part 16b moves to step St103, the zero setting process is performed. When the current forward swing speed τLv(t) is lower than the last forward swing speed τLv(t−1) (“No”) in step St102, the arithmetic processing part 16b moves to step St105. When the arithmetic processing part 16b moves to step St105, the reduction process is performed. The zero setting process and the reduction process will be described later.

Adjustment Process

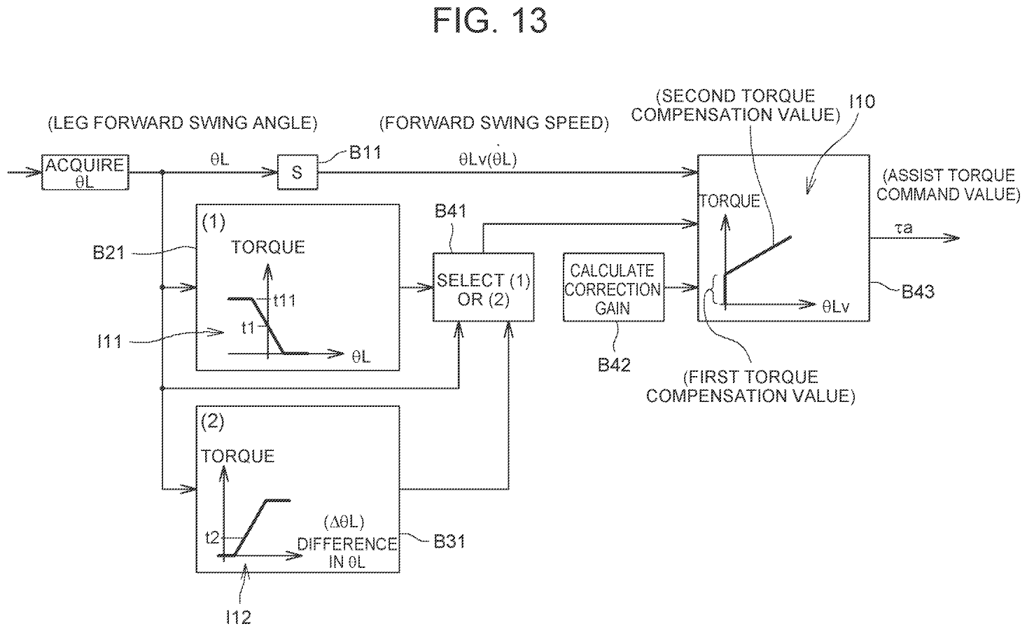

The adjustment process in step St107 shown in FIG. 11 will be described. FIG. 13 is a block diagram showing the adjustment process. Here, the storage device 17 of the control device 15 stores first torque information I11 and second torque information I12.

As shown in block B21 of FIG. 13, the first torque information I11 is information that indicates a relation between the forward swing angle θL of the idling leg of the user and a torque compensatory value. The first torque information I11 is information in which the torque compensatory value becomes smaller (i.e., decreases) as the forward swing angle θL of the idling leg changes from a negative value toward zero. In particular, in this embodiment, the first torque information I11 is information in which the torque compensatory value becomes smaller as the forward swing angle θL of the idling leg changes from a negative value toward zero, and in which the torque compensatory value becomes zero when the forward swing angle θL of the idling leg exceeds zero and becomes equal to or larger than a predetermined angle.

As shown in block B31 of FIG. 13, the second torque information I12 is information that indicates a relation between the torque compensatory value and a value ΔτL obtained by subtracting the forward swing angle θL of the idling leg of the user from the forward swing angle θL of the supporting leg of the user. The second torque information I12 is information in which the torque compensatory value remains zero while the value ΔτL is within a range from a set negative value to a set positive value, and in which, when the value ΔτL exceeds the set positive value, the torque compensatory value increases up to an upper limit value as the value ΔτL increases. The set positive value is a relatively small value that is close to zero. The set negative value is an arbitrary value.

Each block of the adjustment process (see FIG. 13) performed by the arithmetic processing part 16b will be described. In block B11, when the forward swing angle θL of the idling leg is acquired, the forward swing speed τLv of the idling leg is obtained using this forward swing angle θL.

In block B21, the torque compensatory value is obtained based on the acquired forward swing angle θL of the idling leg. In block B31, the torque compensatory value is obtained based on the acquired forward swing angles τL of the supporting leg and the idling leg. That is, the torque compensatory value is obtained based on the value ΔτL obtained by subtracting the forward swing angles τL of the idling leg from the forward swing angles τL of the supporting leg.

In block B41, one of the first torque information I11 and the second torque information I12 is selected based on the forward swing angle θL of the idling leg of the user. When the forward swing angle θL of the idling leg of the user is equal to or smaller than a predetermined angle, the first torque information I11 is selected. When the forward swing angle θL of the idling leg of the user is larger than the predetermined angle, the second torque information I12 is selected. In this embodiment, the predetermined angle is equal to the angle of the posture reference line L0 relative to the vertical line, and is, for example, five degrees, but may have other value (e.g., zero degrees).

In this embodiment, as described above, when a leg is present ahead of the posture reference line L0, the forward swing angle θL of that leg is defined as a positive angle, and when a leg is present behind the posture reference line L0, the forward swing angle θL of the leg is defined as a negative angle. For example, when the forward swing angle θL of the idling leg is −15 degrees, this forward swing angle θL (−15 degrees) is equal to or smaller than the angle of the posture reference line L0 (five degrees). In this case, the first torque information I11 is selected in block B41.

In block B43, the torque compensatory value obtained using the torque information selected in block B41 is determined as the first torque compensation value. That is, the torque compensatory value obtained using the torque information selected in block B41 is used as the first torque compensation value in the correspondence information I10. Thus, in the adjustment process, the first torque compensation value changes. The inclination (the rate of change) of the second torque compensation value shown in the correspondence information I10 is fixed. In the following, the adjustment process will be specifically described.

### Example 1

When the user changes the positions of his or her right and left legs in the front-back direction, for example, to change his or her posture, and the forward swing angle θL of the idling leg at that time is equal to or smaller than the predetermined angle (five degrees), the first torque information I11 is selected in block B41 shown in FIG. 13. According to the first torque information I11, when the forward swing angle θL of the idling leg is small, for example, close to zero, the torque compensatory value is a relatively small value (t1). This torque compensatory value t1 is used as the first torque compensation value in the correspondence information I10. Thus, the first torque compensation value in the correspondence information I10 is set to a small value. As a result, according to the correspondence information I10, when the forward swing speed τLv of the idling leg is especially low, the assist torque command value τa is set to a small value and generation of large assist torque can be avoided.

### Example 2

In Example 2 different from Example 1, when the user changes the positions of his or her right and left legs in the front-back direction, for example, to change his or her posture, and the forward swing angle θL of the idling leg at that time is larger than the predetermined angle (five degrees) as shown in (A) and (B) of FIG. 10, the second torque information I12 is selected in block B41. Also in this case, the value ΔτL obtained by subtracting the forward swing angle of the idling leg from the forward swing angle of the supporting leg is relatively small. Therefore, according to the second torque information I12, the torque compensatory value is a small value (t2). This torque compensatory value t2 is used as the first torque compensation value in the correspondence information I10. Thus, the first torque compensation value in the correspondence information I10 is set to a small value. As a result, according to the correspondence information I10, when the forward swing speed τLv of the idling leg is especially low, the assist torque command value τa is set to a small value and generation of large assist torque can be avoided.

### Example 3

Unlike Examples 1 and 2, when the user is walking as shown in (C) of FIG. 10 and the forward swing angle θL of the idling leg at that time is equal to or smaller than the predetermined angle (five degrees), the first torque information I11 is selected in block B41. In this case, as the user is walking, his or her idling leg is located far back. This means that the forward swing angle θL of the idling leg has a large value on the negative side (e.g., τL=−15 degrees). In this case, according to the first torque information I11, the torque compensatory value is a relatively large value (t11). This torque compensatory value t11 is used as the first torque compensation value in the correspondence information I10. Thus, the first torque compensation value in the correspondence information I10 is set to a relatively large value. As a result, according to the correspondence information I10, the command value τa of assist torque to be provided to the idling leg becomes larger as the forward swing speed τLv of the idling leg becomes higher, thereby enabling the assist operation for the walking action.

### Example 4

When the user performs a walking action of climbing steps, for example, the user tends to assume a forward leaning posture and the forward swing angle θL of his or her idling leg sometimes exceeds the predetermined angle (five degrees). In this case, the second torque information I12 may be selected in block B41. In the case of a walking action of climbing steps, the value ΔτL of the difference in the forward swing angle between the idling leg and the supporting leg is large. Therefore, according to the second torque information I12, the first torque compensation value is set to a large value to enable the assist operation for the walking action of climbing steps.

Assist Device of Embodiment

The assist device 10 disclosed herein is provided, with focus on a difference in the motion of the right and left legs (thighs BF) of a user between when the action of the user is a walking action, as shown in (C) of FIG. 10, and when the user moves his or her legs a little, for example, when the user changes the positions of his or her right and left legs in the front-back direction to change his or her posture while standing, as shown in (A) and (B) of FIG. 10. The assist device 10 of the embodiment includes the swing angle sensors (second detectors) 52 that detect the forward swing angles τL of the right and left legs of the user, and the control device 15 that performs control to operate the actuator 9. The control device 15 repeatedly performs the process of obtaining the assist torque command value τa, and when assist torque is obtained, performs control to operate the actuator 9 at an output based on the command value τa.

As described above, the arithmetic processing part 16b of the control device 15 obtains the command value τa based on detection results of the swing angle sensors 52 and using the correspondence information I10 that indicates the relation between the torque compensation value including the first torque compensation value and the second torque compensation value and the forward swing speed τLv of a leg (see FIG. 8 and block B43 of FIG. 13). Further, when obtaining the command value τa, the arithmetic processing part 16b can perform the adjustment process of changing the first torque compensation value in the correspondence information I10 based on the forward swing angle θL of the leg of the user, as in Examples 1 to 4 described above.

The assist device 10 obtains the command value τa for assist torque to be generated using the correspondence information I10. When obtaining the command value τa, the arithmetic processing part 16b changes the basic torque value (first torque compensation value) included in the torque compensation value of the correspondence information I10 based on the forward swing angles τL of the right and left legs (thighs BF) of the user.

In the embodiment, the first torque information I11 or the second torque information I12 is selected in block B41 shown in FIG. 13, and the torque compensatory value obtained using the selected torque information is determined as the first torque compensation value in the correspondence information I10. Thus, the first torque compensation value changes.

Therefore, when the user moves his or her legs, for example, to change his or her posture, the first torque compensation value can be reduced as in Examples 1 and 2, so that generation of large assist torque can be avoided. On the other hand, when the user performs a walking action, the first torque compensation value can be set to a certain value as in Examples 3 and 4, and as a result, assist torque required for the walking action can be generated. Thus, when the user merely moves his or her legs to change his or her posture, the assist torque to be generated can be reduced, which can reduce the likelihood of causing the user to have a feeling of discomfort.

In the embodiment, the adjustment process is performed on the following condition. As shown in FIG. 11 and FIG. 12, the adjustment process shown in FIG. 13 is performed (step St107) when the forward swing speed τLv(t) of the idling leg of the right and left legs of the user is higher than the predetermined value α (0.1 [rad/s]) (“Yes” in step St101) and equal to or higher than the last forward swing speed θLv(t−1) of the idling leg (“Yes” in step St102), and the last forward swing speed τLv(t−1) of the idling leg is equal to or lower than the predetermined value β (0.1 [rad/s]) (“No” in step St104), in the case where the command value τa is obtained.

When this condition is met at the current timing of obtaining the command value τa, it is assumed that the user is highly likely to have just started to move at the current timing of obtaining the command value τa, and the adjustment process is performed according to the action of the user.

As shown in FIG. 11 and FIG. 12, instead of the adjustment process, the continuation process of setting the current value of the first torque compensation value to the same value as the last value of the first torque compensation value is performed (step St106) when the forward swing speed τLv(t) of the idling leg of the right and left legs of the user is higher than the predetermined value α (0.1 [rad/s]) (“Yes” in step St101) and equal to or higher than the last forward swing speed τLv(t−1) of the idling leg (“Yes” in step St102), and the last forward swing speed τLv(t−1) of the idling leg is higher than the predetermined value β (0.1 [rad/s]) (“Yes” in step St104), in the case where the command value τa is obtained.

When this condition is met at the current timing of obtaining the command value τa, it is assumed that the user is highly likely to continue walking at the current timing of obtaining the command value τa, and the continuation process is performed to maintain the first torque compensation value.

As shown in FIG. 11 and FIG. 12, instead of the adjustment process or the continuation process, the reduction process is performed (step St105) when the forward swing speed τLv(t) of the idling leg of the right and left legs of the user is higher than the predetermined value α (0.1 [rad/s]) (“Yes” in step St101) and lower than the last forward swing speed τLv(t−1) of the leg (“No” in step St102), in the case where the command value τa is obtained. In the reduction process, the current first torque compensation value is set to a value obtained by multiplying the last first torque compensation value by a coefficient smaller than 1 (e.g., 0.9).

Since the forward swing speed θLv of the idling leg is lower at the current timing of obtaining the command value τa than at the last timing of obtaining the command value τa, the first torque compensation value is reduced. As a result, assist torque smaller than the last value of the assist torque is provided to the user.

In FIG. 11 and FIG. 12, instead of the adjustment process, the continuation process, or the reduction process, the zero setting process is performed (step St103) when the forward swing speed τLv(t) of the idling leg of the right and left legs of the user is equal to or lower than the predetermined value α (0.1 [rad/s]) (“No” in step St101), in the case where the command value τa is obtained. In the zero setting process, the current first torque compensation value is set to zero. In this case, the user is assumed to be substantially stationary and generation of assist torque can be avoided.

As has been described above, the assist device 10 of the embodiment can generate assist torque according to the action of the user and provide the user with the assist torque.

Assist Device 10 in Another Form

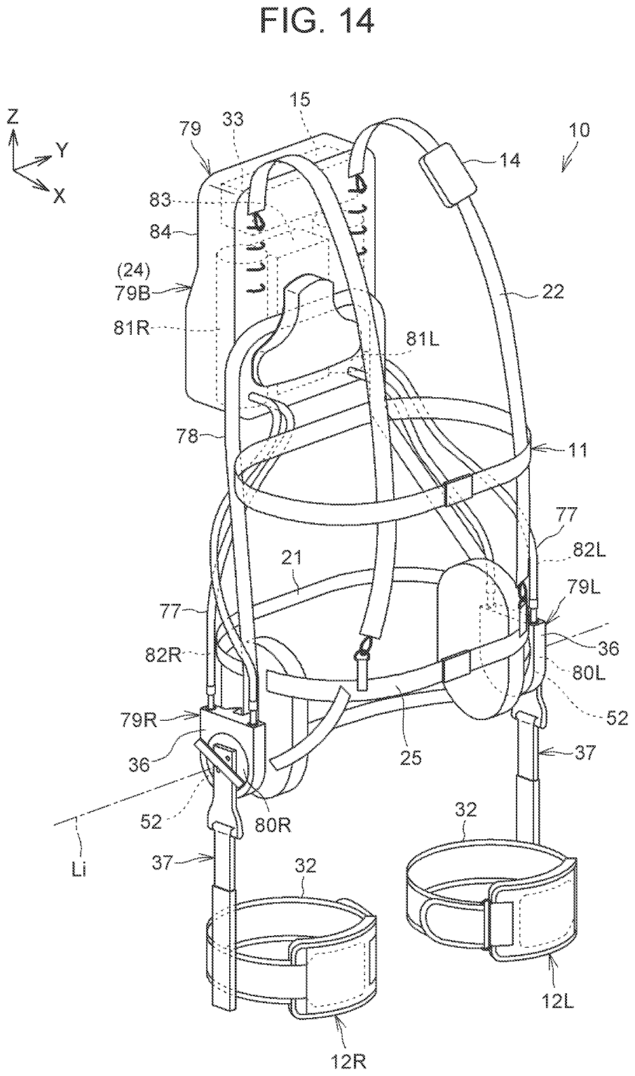

FIG. 14 is a perspective view showing an assist device 10 in another form. Like the assist device 10 shown in FIG. 1, this assist device 10 includes a first body-worn unit 11 that is worn on the upper body of the user including at least his or her hips, right and left second body-worn units 12R, 12L that are worn on the thighs of the right and left legs of the user, and an actuator 79. Those members that have the same function in the assist device 10 shown in FIG. 1 and in the assist device 10 shown in FIG. 14 are denoted by the same reference signs.

The actuator 79 includes a power unit 79B that corresponds to the backpack 24 in the form shown in FIG. 1, a left driving unit 79L that is provided so as to correspond to the left side of the hip of the user, and a right driving unit 79R that is provided so as to correspond to the right side of the hip of the user. The power unit 79B and each of the right and left driving units 79R, 79L are coupled together by a frame 78 made of metal or the like. The first body-worn unit 11 is mounted on the actuator 79 including the power unit 79B and the right and left driving units 79R, 79L.

The power unit 79B includes, inside a case 84, a motor 83 and right and left driving pulleys 81R, 81L that are driven to rotate by the motor 83. A triaxial acceleration sensor 33 is provided inside the power unit 79B as a tilt angle detection part that obtains the tilt angle of the upper body of the user. The left driving unit 79L is provided with a driven pulley 80L inside a case 36. The right driving unit 79R is provided with a driven pulley 80R inside a case 36. Each of the right and left driven pulleys 80R, 80L is provided inside the case 36 so as to be able to turn in one direction and the other direction around an imaginary line Li that passes through the user at a position near his or her hips in the right-left direction. On the left side, a wire 82L is wrapped around the driving pulley 81L and the driven pulley 80L, and on the right side, a wire 82R is wrapped around the driving pulley 81R and the driven pulley 80R. The wires 82R, 82L are respectively housed in guide pipes 77 that are provided between the power unit 79B and the right and left cases 36.

When the right and left driving pulleys 81R, 81L are turned in the one direction by the motor 83, the right and left driven pulleys 80R, 80L are turned in the one direction, with the wires 82R, 82L functioning as power transmission members. When the driving pulleys 81R, 81L are turned in the other direction by the motor 83, the driven pulleys 80R, 80L are turned in the other direction, with the wires 82R, 82L functioning as power transmission members. Arms 37 are respectively mounted on the driven pulleys 80R, 80L, and each of the driven pulleys 80R, 80L moves integrally with the arm 37. The second body-worn units 12R, 12L are mounted at lower parts of the arms 37.

Torque of the right and left arms 37 swinging around the imaginary line Li as a result of turning of the driven pulleys 80R, 80L is provided to the user as assist torque. Thus configured, the actuator 79 performs assist operation of providing the user with an assist force through the first body-worn unit 11 and the second body-worn units 12R, 12L.

The assist device 10 shown in FIG. 14 also includes sensors 52 that detect the forward swing angles of the right and left legs (thighs) of the user, and a control device 15 that performs control to operate the actuator 79. As in the form shown in FIG. 1, the control device 15 repeatedly performs a process of obtaining the command value τa for assist torque to be generated, and performs control to operate the actuator 79 at an output based on the command value τa. As in the form shown in FIG. 1, the sensors 52 are configured to detect the swing angles of the arms 37. The sensors 52 are, for example, sensors (e.g., encoders or angle sensors) that detect the rotation angles of the driven pulleys 80R, 80L that move integrally with the arms 37. Since the rotation angle of the driven pulley 80L (80R) and the rotation angle of the driving pulley 81L (81R) are correlated with each other, the sensor 52 may be configured to detect the swing angle of the arm 37, i.e., the forward swing angle of the leg (thigh) based on the rotation angle of the driving pulley 81L (81R).

Also in the assist device 10 shown in FIG. 14, the control device 15 includes a processing unit 16, and the processing unit 16 (arithmetic processing part 16b) obtains the assist torque command value τa based on detection results of the sensors 52 and using the correspondence information I10 (FIG. 8). When obtaining the command value ta, the processing unit 16 can perform the adjustment process of changing the first torque compensation value in the correspondence information I10 based on the forward swing angle θL of the leg of the user. As shown in FIG. 11 and FIG. 12, the processing unit 16 can perform the continuation process, the reduction process, and the zero setting process instead of the adjustment process according to the predetermined conditions. The processes performed by the processing unit 16 are the same as in the assist device 10 shown in FIG. 1, and therefore a detailed description thereof will be omitted here.

Also in the assist device 10 shown in FIG. 14, when the user changes the positions of his or her right and left legs in the front-back direction, for example, to change his or her posture, the first torque compensation value in the correspondence information I10 is set to a small value. As a result, the assist torque command value τa is set to a small valued and generation of large assist torque can be avoided. When the user is performing a walking action, an assist torque command value τa according to the walking action is obtained and assist torque for the walking action can be generated.

The mechanisms of the respective parts of the assist device 10 may have configurations different from those shown in the drawings. For example, the first body-worn unit 11 may have a form different from that shown in the drawings, as long as it is configured to be worn at least on the hips BW of the user. The second body-worn units 12R, 12L may have forms different from those shown in the drawings, as long as they are configured to be worn on the thighs BF of the right and left legs of the user. The configuration of the actuator 9 may also be different, as long as it includes the arms 37 that provide the user with assist torque by swinging back and forth.

The embodiment disclosed this time is in every respect merely illustrative and not restrictive. The scope of the right for the disclosure is not limited to the above embodiment and includes all changes within a scope equivalent to the configuration described in the claims.

What is claimed is:

1. An assist device comprising:
a first body-worn unit that is worn at least on hips of a user;
second body-worn units that are worn on thighs of right and left legs of the user;
an actuator configured to generate assist torque that assists the user in moving the hips of the user relatively to the thighs of the user, and moving the thighs of the user relatively to the hips of the user;
a sensor configured to detect forward swing angles of the right and left legs of the user; and
a controller configured to repeatedly perform a process of obtaining a command value for the assist torque to be generated, and perform control to operate the actuator at an output based on the command value, wherein:
the controller includes a processing unit configured to obtain the command value based on a detection result of the sensor and using correspondence information that indicates a relation between a forward swing speed of a leg of the right and left legs and a torque compensation value including a first torque compensation value and a second torque compensation value, the first torque compensation value being a value of basic torque, the second torque compensation value being a torque value that increases with an increase in the forward swing speed of the leg that is an idling leg; and
the processing unit is configured to perform an adjustment process of changing the first torque compensation value based on the forward swing angle of at least one of the right and left legs of the user, in a case where the processing unit obtains the command value.

2. The assist device according to claim 1, wherein:
when one leg of the right and left legs is present ahead of a posture reference line that passes through an upper body of the user, the forward swing angle of the one leg is defined as a positive angle, and when one leg of the right and left legs is present behind the posture reference line, the forward swing angle of the one leg is defined as a negative angle;
the processing unit is configured to, as the adjustment process, select first torque information when the forward swing angle of the idling leg of the user is equal to or smaller than a predetermined angle, select second torque information when the forward swing angle of the idling leg of the user is larger than the predetermined angle, and determine, as the first torque compensation value, a torque compensatory value obtained using selected one of the first torque information and the second torque information;
the first torque information is information that indicates a relation between the forward swing angle of the idling leg of the user and the torque compensatory value, and in the first torque information, the torque compensatory value decreases as the forward swing angle of the idling leg changes from a negative value toward zero; and
the second torque information is information that indicates a relation between the torque compensatory value and a value obtained by subtracting the forward swing angle of the idling leg of the user from the forward swing angle of a supporting leg of the user, and in the second torque information, the torque compensatory value remains zero while the obtained value is within a range from a set negative value to a set positive value, and after the obtained value exceeds the set positive value, the torque compensatory value increases as the obtained value increases.

3. The assist device according to claim 1, wherein the processing unit is configured to perform the adjustment process when the forward swing speed of the idling leg of the right and left legs is higher than a predetermined value and equal to or higher than a last value of the forward swing speed of the idling leg, and the last value of the forward swing speed of the idling leg is equal to or lower than the predetermined value, in the case where the processing unit obtains the command value.

4. The assist device according to claim 1, wherein the processing unit is configured to perform, instead of the adjustment process, a continuation process of setting a current value of the first torque compensation value to a same value as a last value of the first torque compensation value when the forward swing speed of the idling leg of the right and left legs of the user is higher than a predetermined value and equal to or higher than a last value of the forward swing speed of the idling leg, and the last value of the forward swing speed of the idling leg is higher than the predetermined value, in the case where the processing unit obtains the command value.

5. The assist device according to claim 1, wherein the processing unit is configured to perform, instead of the adjustment process, a reduction process of setting a current value of the first torque compensation value to a value obtained by multiplying a last value of the first torque compensation value by a coefficient smaller than 1 when the forward swing speed of the idling leg of the right and left legs of the user is higher than a predetermined value and lower than a last value of the forward swing speed of the idling leg, in the case where the processing unit obtains the command value.

6. The assist device according to claim 1, wherein the processing unit is configured to perform, instead of the adjustment process, a zero setting process of setting a current value of the first torque compensation value to zero when the forward swing speed of the idling leg of the right and left legs of the user is equal to or lower than a predetermined value, in the case where the processing unit obtains the command value.
